(19) United States
(12) Patent Application Publication
(10) Pub. No.: US 2026/0089568 A1
(43) Pub. Date: Mar. 26, 2026

(54) SYSTEMS AND METHODS FOR CELL CAPACITY ESTIMATION

(71) Applicant: Verizon Patent and Licensing Inc., Basking Ridge, NJ (US)

(72) Inventors: Jignesh S. Panchal, Hillsborough, NJ (US); John N. Wakim, Salem, NH (US)

(21) Appl. No.: 18/895,689

(22) Filed: Sep. 25, 2024

(51) Int. Cl. H04W 28/16; H04W 28/02; H04W 64/00

(52) U.S. Cl. CPC H04W 28/16; H04W 28/0226; H04W 64/003

(57) ABSTRACT

Systems and methods provide a total cell capacity estimation process that accounts for variability of spectral efficiency (SE) within a cell and enables optimized cell adjustments. A network device obtains field data of user equipment (UE) devices for a cell and assigns, based on the field data, multiple zones within the cell. Each of the multiple zones corresponds to a different link adaptation setting for UE devices. The network device computes a total data transfer capacity in a band for each zone of the multiple zones, and estimates a current available remaining data transfer capacity for each zone of the multiple zones based on the field data and the total data transfer capacity for each zone.

### BACKGROUND INFORMATION

Development and design of networks present certain challenges from a network-side perspective and an end device perspective. For example, Next Generation (NG) wireless networks, such as Fifth Generation New Radio (5G NR) networks are being deployed and under continuous development. One aspect of 5G NR and future wireless network development involves radio access network (RAN) management, planning, and optimization.

Next Generation mobile networks, such as those implementing 5G NR standards, are expected to enable a higher utilization capacity than current wireless networks, permitting a greater density of wireless users. Next Generation mobile networks are designed to increase data transfer rates, increase spectral efficiency, improve coverage, improve capacity, and reduce latency.

### BRIEF DESCRIPTION OF THE DRAWINGS

FIGS. 1A and 1B are diagrams illustrating concepts described herein;

FIG. 2 is a diagram illustrating a network environment according to an implementation described herein;

FIG. 3 is a diagram illustrating example components of a device that may be included in a network environment, according to an implementation described herein;

FIG. 4 is a diagram illustrating a total cell capacity estimation process, according to an implementation described herein;

FIG. 5 is a diagram illustrating a planning scenario for new device placement and/or increased mobility use within sector; and

FIG. 6 is a flow diagram illustrating an exemplary process for managing total cell capacity over a band in a cell or sector, according to an implementation described herein.

### DETAILED DESCRIPTION

The following detailed description refers to the accompanying drawings. The same reference numbers in different drawings identify the same or similar elements. Also, the following detailed description does not limit the invention.

Radio Access Network (RAN) management, planning, and optimization are highly complex endeavors for network operators, network management personnel, and the like. For example, the ability to understand network capacity and coverage gaps, optimize existing network infrastructure, analyze impact of prospective new radio site placements, calculate new radio or RAN device parameters and radio coverage areas, and the like can be technically challenging and complex. Obtaining an accurate estimation of cell capacity for each cell can significantly aid RAN management, planning, and optimization. Each cell has a finite number of physical resource blocks (PRBs) available to carry over-the-air data transmissions in the cell. The efficiency of each radio link to transmit data may influence the allocation of the PRBs and, thus, the data transmission capacity of the cell.

As a further factor, different service types may be provided via a 5G RAN. In one example, the different service types may include regular User Equipment (UE) cellular service and a Fixed Wireless Access (FWA) service. Regular UE cellular service may include mobility-type services, voice services, Internet of Things services, and the like. In contrast, FWA service employs standardized mobile network architectures and common mobile network components to deliver ultra-high-speed broadband services to fixed location residential and business subscribers, without having to lay optical fiber or cables to provide wireless broadband connectivity. In a mobile network that implements FWA, residents or businesses may use a FWA gateway (e.g., a 5G Residential Gateway (RG)) to provide a connection between the network equipment (e.g., within a home or business) and the mobile core network. The FWA gateway operates as a gateway between the mobile network and a downstream Local Area Network (LAN), to which the residential or business located user equipment (UE) devices connect. Placement of a FWA within a cell can have a much greater impact on localized RAN capacity than, for example, a traditional UE device or Internet of Things (IoT) device using regular cellular service.

Furthermore, a cell's capacity to support FWA devices and UE devices can be highly dependent on the location of a FWA device or UE device within the cell. RAN management, planning, and optimization efforts typically rely on a single value that represents the average total capacity for each cell. However, capacity levels are not homogeneous within a sector or cell. As described further herein, capacity density zones may be defined within each cell to more precisely track and predict demand within the cell.

Systems and methods described herein provide a total cell capacity estimation process that accounts for variability of spectral efficiency (SE) within a cell. The systems and methods further provide tools for managing total cell capacity over a band in a cell or sector. Downlink (DL) and uplink (UL) capacity planning are generally done separately as independent processes. The systems and methods described herein are applicable to both DL and UL capacity estimation/planning.

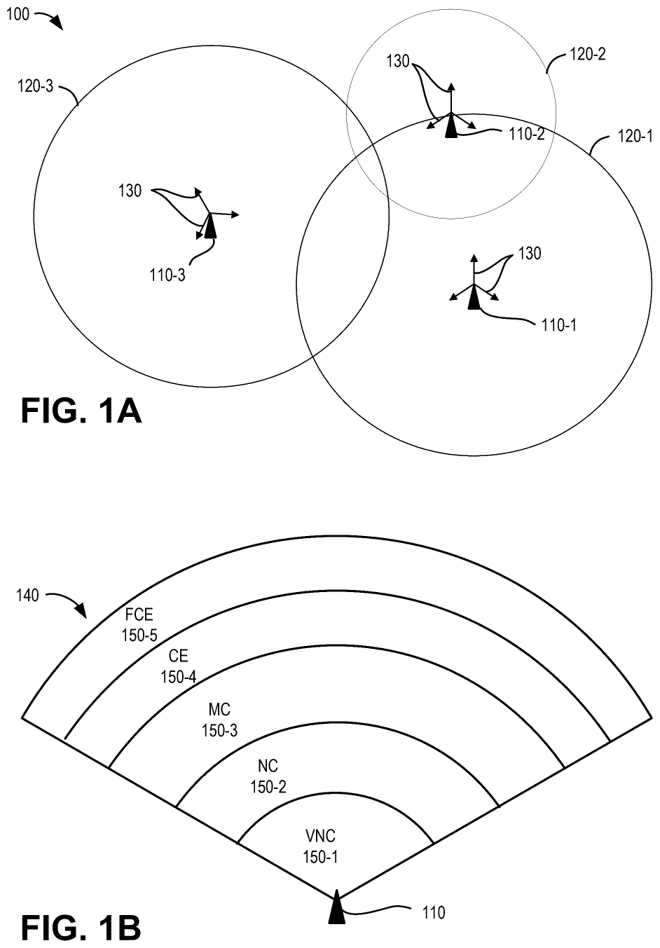

FIG. 1A and 1B provide an illustration of concepts described herein. FIG. 1A is a schematic of a RAN environment 100 that includes multiple RAN devices 110. A RAN device 110 may include, for example, a device or base station to enable access to a mobile network. RAN devices 110 (referred to individually as RAN device 110-1, 110-2, . . . 110-n) may define coverage areas 120 (referred to individually as coverage areas 120-1, 120-2, . . . 120-n) which may cover a geographic area of a RAN. A coverage area typically uses multiple carrier frequencies to meet capacity demands and provide guaranteed service quality within each area, although not all carrier frequencies are typically applied on every area. Each coverage area 120 may be divided into sectors 130 (e.g., 2, 3, 6 sectors, etc.), with each sector 130 providing different areas of coverage that may overlap. A particular sector 130 may also transmit and/or receive signals on one or more predefined carrier frequencies. A particular carrier frequency in a particular sector 130 may be referred to herein as a “sector-carrier” or a “cell.” As shown in FIG. 1A, radio frequency (RF) signals used by a first access station 110-1 (e.g., with coverage area 120-1) may overlap with RF signals used in one or more neighboring access stations 110 (e.g., with coverage areas 120-2 and 120-3).

FIG. 1B is a schematic of a cell 140, according to an implementation. As shown in FIG. 1B, cell 140 may be segmented into different capacity zones 150 (referred to individually as capacity zones 150-1, 150-2, . . . 150-n). Each capacity zone 150 may represent a different data transfer capacity (e.g., for uplink and/or downlink data transfer). Generally, zones closer to a transceiver (e.g., of RAN device 110) will have greater radio link efficiency (e.g., with minimal retransmissions), while zones 150 farther from the transceiver will have lower data transfer capacity (e.g., with higher levels of retransmissions). According to some implementations, each capacity zone 150 may correspond to different link adaptations, such as aggregation and/or repetition techniques (e.g., Physical Downlink Shared Channel (PDSCH), Physical Uplink Shared Channel (PUSCH), Physical Uplink Control Channel (PUCCH) slot aggregation, Physical Downlink Control Channel (PDCCH) slot aggregation, etc.) depending on whether the zones are capacity zones for UL or DL.

For example, for DL capacities, each zone 150 may correspond to a different PDCCH Grant Aggregation Level (e.g., the number of consecutive Control Channel Elements (CCEs) required to carry a single PDCCH grant) determined for UE devices in an area of cell 140. Thus, in the implementation of FIG. 1B, a closest zone 150-1 to RAN device 110, very near cell (VNC), may correspond to an area of coverage in cell 140 where devices may be assigned to use PDCCH aggregation level 1. A next closest zone 150-2, near cell (NC), may correspond to an area of coverage where devices may use aggregation level 2. A middle zone 150-3, mid-cell (MC), may correspond to an area of coverage where devices may use aggregation level 4. A next farthest zone 150-4, cell edge (CE), may correspond to an area of coverage where devices may use aggregation level 8. A farthest zone 150-5, far cell edge (FCE), may correspond to an area of coverage where devices may use aggregation level 16.

In another implementation (e.g., for UL capacities), zones 150 may be defined based on PUSCH signal-to-interference and noise-ratio (SINR) measurements by RAN devices 110. In still another implementation, zones 150 may be defined based on channel quality indicator (CQI) and/or rank indicator (RI) distributions based on information sent by UE devices to RAN devices 110. Although five capacity zones 150 are illustrated in FIG. 1B, in other implementations, more or fewer capacity zones 150 may be defined for a cell 140. FIG. 1B provides a simplified illustration of capacity zones 150 in a single cell 140. As described further herein, capacity zones 150 may be applied in multiple cells 140. In other implementations, zones 150 may be applied for entire coverage areas 120.

Use of zones 150 enables more accurate estimation and forecasting of cell capacity density. Cell capacity density may refer to the different coverage areas (or zones) within a cell that have different radio link efficiency (also referred to as spectral efficiency). Zones 150 may be used to provide a more accurate picture of a cell's total capacity, as well as enabling estimates for cell demand growth density and better capacity projections. For example, demand growth may be projected based on a per cell and per zone basis. Furthermore, zone information may be supplemented with service type indicators, such that network administrators may estimate the total cell capacity and subsequent distribution of capacity per services, such as FWA, basic mobility, and other network slices. The network administration systems may estimate the demand growth per cell 140, per zone 150, and per service type, allowing for better capacity projection and forecasting per service.

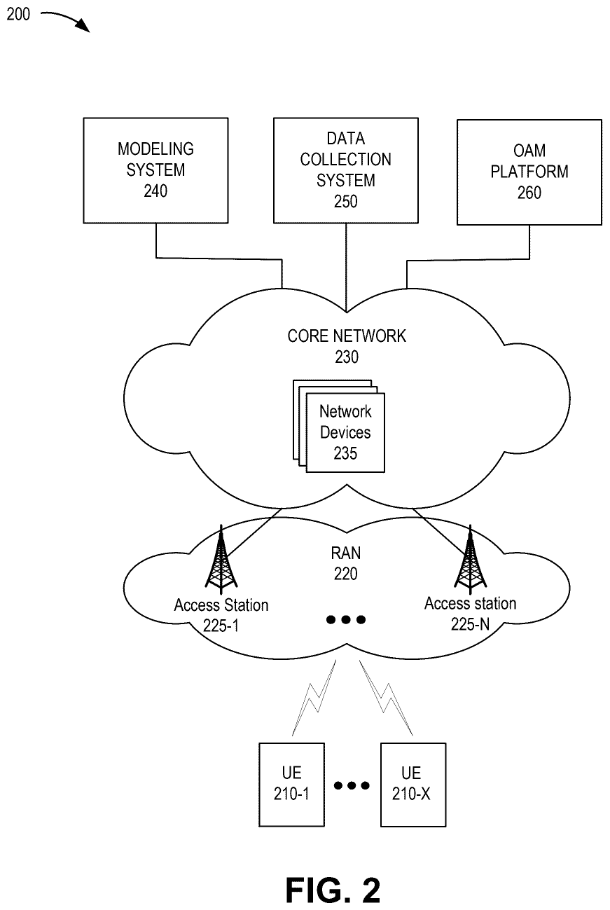

FIG. 2 is a diagram of an exemplary environment 200 in which the systems and/or methods, described herein, may be implemented. As shown in FIG. 2, environment 200 may include UE devices 210-1 to 210-X (referred to herein collectively as “UE devices 210” and individually as “UE device 210”), a RAN 220, a core network 230, a capacity density modeling system 240, a data collection system 250, and an Operation, Administration, and Management (OAM) platform 260.

UE device 210 may include any device with long-range (e.g., cellular or mobile wireless network) wireless communication functionality. For example, UE device 210 may include a handheld wireless communication device (e.g., a mobile phone, a smart phone, a tablet device, etc.); a wearable computer device (e.g., a wristwatch computer device, etc.); a portable computer; a customer premises equipment (CPE) device, such as a set-top box or a digital media player, a wireless Local Area Network (LAN) (e.g., WI-FI) access point, a smart television, etc.; a mobile device; a portable gaming system; global positioning system (GPS) device; a home appliance device; a home monitoring device; and/or any other type of computer device with wireless communication capabilities. Other examples of UE device 210 may include a machine-type communication (MTC) device, an Unmanned Aerial Vehicle (UAV), and an autonomous terrestrial vehicle. In one implementation, UE device 210 may also include a FWA device, as described above, where communications with a FWA device and other UE devices are differentiated via service type designations.

According to an implementation, UE devices 210 may provide (e.g., to data collection system 250) historical measurement reports that may include location coordinates (e.g., Global Positioning System (GPS), assisted GPS, etc.) and received signal strength measurements (such as Reference Signal Received Power (RSRP) measurements) from detectable access stations 225 seen at an instance of time. Other examples of signal strength measurements may include a Received Signal Strength Indicator (RSSI), a Reference Signal Received Quality (RSRQ) value, a signal-to-noise ratio (SNR), a signal-to-interference-plus-noise ratio (SINR), or another type of channel condition value. Measurement reports and other mobile UE device data may be generically referred to herein as “field data.”RAN 220 may enable UE devices 210 to connect to core network 230 for mobile telephone service, text message services, Internet access, cloud computing, and/or other types of data services. RAN 220 may include one or multiple networks of one or multiple types and technologies. For example, RAN 220 may include a Fifth Generation (5G) RAN, a Fourth Generation (4G) RAN, a 4.5G RAN, and/or another type of future generation RAN. By way of further example, RAN 220 may be implemented to include a Next Generation (NG) RAN, an Evolved UMTS Terrestrial Radio Access Network (E-UTRAN) of a Long-Term Evolution (LTE) network, an LTE-Advanced (LTE-A) network, and/or an LTE-A Pro network, and/or another type of RAN (e.g., a legacy RAN).

RAN 220 may include radio access stations 225-1 to 225-N (herein collectively referred to as “access stations 225” and individually as “access station 225”). Access station 225 may include one or more devices and other components that allow UE devices 210 to wirelessly connect to RAN 220. Access stations 225 may correspond, for example, to RAN devices 110 of FIG. 1. Access station 225 may include RAN devices 110, such as a next generation Node B (gNB), an enhanced LTE (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a distributed unit (DU), a small cell node (e.g., a picocell device, a femtocell device, a microcell device, a home eNB, a home gNB, etc.), a 5G ultra-wide band (UWB) node, a future generation wireless access device (e.g., a 6G wireless station or another generation of wireless station).

Each access station 225 may service a set of UE devices 210. For example, access station 225-1 may service some UE devices 210 when the UE devices 210 are located within the geographic area (e.g., coverage area 120-1) serviced by access station 225-1, while other UE devices 210 may be serviced by another access station 225 when the UE devices 210 are located within the geographic area (e.g., coverage area 120-3) serviced by the other access station 225. Access stations 225 may connect to core network 230 via backhaul links, such as wired or optical links. According to various embodiments, RAN 220 may be implemented according to various wireless technologies (e.g., radio access technology (RAT), etc.), wireless standards, wireless frequencies/bands, and so forth. As described further herein, access stations 225 may provide (e.g., to data collection system 250) historical records of PUSCH SINR measurements (or other signal strength measurements), channel quality indicators (CQIs), and/or PDCCH grant aggregation levels used for connections with UE devices 210. The PUSCH SINR measurements, CQIs, and/or PDCCH grant aggregation levels may also be generically referred to herein as “field data,” along with data that may be reported from UE devices 210.

In some embodiments, access station 225 may include one or more radio frequency (RF) transceivers facing particular directions. For example, access station 225 may include three RF transceivers and each RF transceiver may service a 120-degree sector (e.g., cell 140) of a 360-degree field of view. Each RF transceiver may include an antenna array. The antenna array may include an array of controllable antenna elements configured to send and receive RF signals via one or more antenna beams. The antenna elements may be mechanically or digitally controllable to tilt, or adjust the orientation of, an antenna beam in a vertical direction and/or horizontal direction.

Core network 230 may manage communication sessions for UE devices 210. Core network 230 may provide mobility management, session management, authentication, and packet transport, to support UE device 210 and access station 225 wireless communications. Core network 230 may be compatible with known wireless standards which may include, for example, Third Generation Partnership Project (3GPP) 5G, LTE, LTE Advanced, Global System for Mobile Communications (GSM), Universal Mobile Telecommunications System (UMTS), IS-2000, etc. Some or all of core network 230 may be managed by a communication services provider that also manages RAN 220. Core network 230 may allow the delivery of Internet Protocol (IP) services to UE device 210 and may interface with other external networks. Core network 230 may include one or more server devices and/or network devices, or other types of computation or communication devices (referred to collectively as network devices 235).

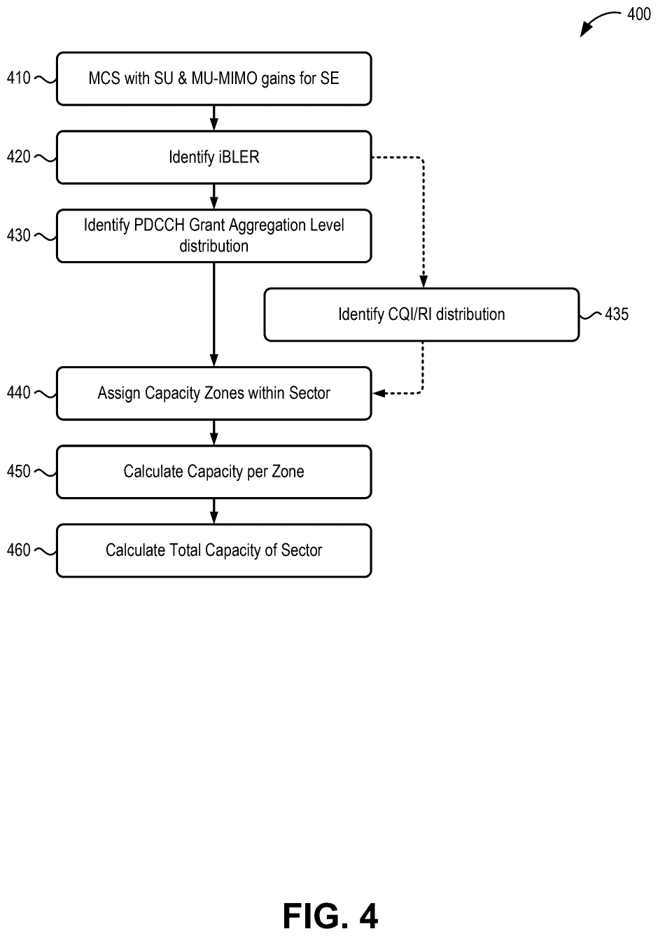

Capacity density modeling system 240 may include one or more devices, such as computing devices, network devices, and/or server devices, which perform modeling of RAN cells and capacity zones associated with the RAN cells. In one implementation, modeling system 240 may include one or more trained machine learning (ML) models. For example, modeling system 240 may include a collaborative framework that is based on a procedure for modeling spectral efficiency and/or capacity zones within each sector or cell. Modeling system 240 is described further, for example, in connection with FIG. 4.

Data collection system 250 may collect and store network data of RAN 220. For example, data collection system 250 may generate records for access stations 225. The records may include location data and identify the configured sector data and corresponding carrier frequencies. Data collection system 250 may also obtain mobility pattern data for UE devices 210 within RAN 220. In one implementation, data collection system 250 may log measurement reports from individual UE devices 210. As noted above, the measurement reports may include actual PUSCH SINR measurements (or other signal strength measurements) or PDCCH grant aggregation levels associated with a time and location. According to implementations described herein, data collection system 250 may provide the RAN data as field data to modeling system 240 for modeling and detection of capacity zones within cells 140.

OAM platform 260 may include one or more devices, such as computing devices, network devices, and/or server devices, which may perform functions related to operations, administration, and management or maintenance of the network. The operations-related functions of OAM platform 260 may include monitoring performance parameters or state parameters of the network. OAM platform 260 may use the monitored parameter values to detect network faults or suboptimal network conditions. The administration functions of the OAM platform 260 may include obtaining analytics to determine performance, for capacity planning, sustaining reliability, and/or billing. For example, OAM platform 260 may apply information from modeling system 240 and data collection system 250 to determine current and future capacity of a cell. The management and/or maintenance functions may include recovery, upgrades, and provisioning devices and/or services.

Although FIG. 2 shows exemplary components of environment 200, in other implementations, environment 200 may include fewer components, different components, differently arranged components, or additional components than depicted in FIG. 2. Additionally, or alternatively, one or more components of environment 200 may perform functions described as being performed by one or more other components of environment 200.

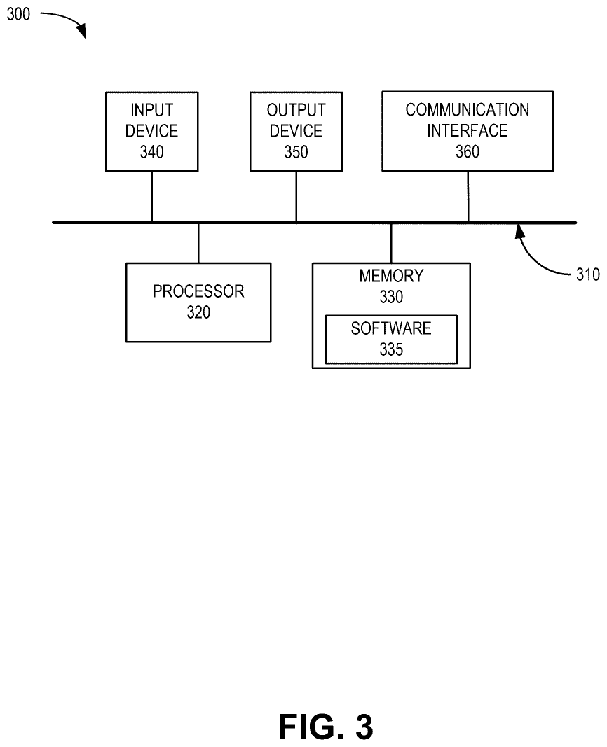

FIG. 3 is a diagram illustrating example components of a device 300 according to an implementation described herein. UE device 210, access station 225, network devices 235, capacity density modeling system 240, data collection system 250, OAM platform 260, and/or other components of network environment 200 may each include one or more devices 300 or may be implemented on one of more devices 300. As shown in FIG. 3, device 300 may include a bus 310, a processor 320, a memory 330 including software 335, an input device 340, an output device 350, and a communication interface 360.

Bus 310 may include a path that permits communication among the components of device 300. Processor 320 may include any type of single-core processor, multi-core processor, microprocessor, latch-based processor, and/or processing logic (or families of processors, microprocessors, and/or processing logic) that interprets and executes instructions. In other embodiments, processor 320 may include an application-specific integrated circuit (ASIC), a field-programmable gate array (FPGA), and/or another type of integrated circuit or processing logic.

Memory 330 may include any type of dynamic storage device that may store information and/or instructions, for execution by processor 320, and/or any type of non-volatile storage device that may store information (e.g., software 335, data, etc.) for use by processor 320. For example, memory 330 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Software 335 includes an application or a program that provides a function and/or a process. Software 335 may also include firmware, middleware, microcode, hardware description language (HDL), and/or another form of instruction. By way of example, with respect to computing elements that include logic to provide RAN models, these network elements may be implemented to include software 335.

Input device 340 may allow an operator to input information into device 300. Input device 340 may include, for example, a keyboard, a mouse, a pen, a microphone, a remote control, an audio capture device, an image and/or video capture device, a touch-screen display, and/or another type of input device. In some embodiments, device 300 may be managed remotely and may not include input device 340.

Output device 350 may output information to an operator of device 300. Output device 350 may include a display, a printer, a speaker, and/or another type of output device. For example, device 300 may include a display, which may include a liquid-crystal display (LCD) for displaying content to the customer. In some embodiments, device 300 may be managed remotely and may not include output device 350.

Communication interface 360 may include a transceiver that enables device 300 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 360 may include a transmitter that converts baseband signals to RF signals and/or a receiver that converts RF signals to baseband signals. Communication interface 360 may be coupled to one or more antennas/antenna arrays for transmitting and receiving RF signals.

Communication interface 360 may include a logical component that includes input and/or output ports, input and/or output systems, and/or other input and output components that facilitate the transmission of data to other devices. For example, communication interface 360 may include a network interface card (e.g., Ethernet card) for wired communications and/or a wireless network interface (e.g., WI-FI) card for wireless communications. Communication interface 360 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 300 may perform operations in response to processor 320 executing instructions (e.g., software 335) contained in a computer-readable medium, such as memory 330. A computer-readable medium may be defined as a non-transitory memory device. A memory device may be implemented within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of, or in combination with, software instructions to implement processes described herein. Thus, implementations described herein are not limited to any specific combination of hardware circuitry and software.

Although FIG. 3 shows exemplary components of device 300, in other implementations, device 300 may include fewer components, different components, additional components, or differently arranged components than depicted in FIG. 3. Additionally, or alternatively, one or more components of device 300 may perform one or more tasks described as being performed by one or more other components of device 300.

FIG. 4 is a flow diagram illustrating a process for estimating a total cell capacity over a band in a cell or sector. Process 400 may be performed, for example, by modeling system 240. In another implementation, process 400 may be performed by modeling system 240 in conjunction with one or more other components of network environment 200.

Referring to block 410, modeling system 240 may identify, for a UE device in a cell, a modulation and coding scheme (MCS) with Single-User (SU)- and Multi-User (MU)-Multi-Input Multi-Output (MIMO) gains for spectral efficiency (SE). The MCS may indicate a combination of two parameters: a code rate (e.g., a ratio of a number of useful bits transmitted to the total number of bits transmitted) and a modulation scheme (e.g., 16 Quadrature Amplitude Modulation (QAM), 64 QAM, etc.).

Referring to block 420, modeling system 240 may identify the initial block error rate (iBLER) used to discount the spectral efficiency. The iBLER may indicate a ratio of blocks with initial transmission errors to the total number of blocks transmitted. If iBLER is below a threshold level, some or all SE settings may be disabled.

Referring to block 430, modeling system 240 may identify the PDCCH grant aggregation level (or PUSCH SINR measurement) distribution, within the cell, to represent the current/true user demand distribution. For example, modeling system 240 may use data from data collection system 250 to identify coverage areas within cell 140 where UE devices 210 have been assigned different PDCCH grant aggregation levels (e.g., aggregation level 1, 2, 4, etc.). In another implementation, modeling system 240 may use data from data collection system 250 to identify coverage areas within cell 140 where UE devices 210 have similar ranges of SINR measurement.

Alternatively, as shown in block 435, modeling system 240 may identify CQI and/or RI distributions within the cell, to represent the current/true user demand distribution. For example, modeling system 240 may use data from data collection system 250 to identify coverage areas within cell 140 where the same or similar CQIs and/or RIs are reported by UE devices 210.

Referring to block 440, modeling system 240 may use the PDCCH grant aggregation level distribution or PUSCH SINR measurement distribution (as determined in block 430) to assign capacity zones 150 within cell 140. Alternatively, modeling system 240 may use the CQI and/or RI distribution (as determined in block 435) to assign capacity zones 150 within cell 140. For example, modeling system 240 may identify zones 150-1 through 150-5, as illustrated in FIG. 1B. While shown in FIG. 1B as uniform continuous zones, in practice, capacity zones 150 may be nonuniform, discontinuous, and/or overlapping due to topographical and other sources of signal interference.

Referring to block 450, after each of zones 150 is defined within cell 140, modeling system 240 may calculate a capacity-per-zone for each zone 150. The capacity-per-zone may allocate a distribution of all available shared data channel physical resource blocks (PRBs) for a licensed band (e.g., C-band, millimeter wave, mid-band, and low-band, etc.). The distribution of PRBs is typically allocated fairly across all active users by a proportional-fair scheduler (e.g., part of access station 225) for cell 140. Alternatively, in a different configuration/implementation of the scheduler, the distribution of PRBs can be biased to users near the access station to maximize cell capacity, or users farther away for the access station to increase edge user experience/speed. Other possibilities are that the scheduler's PRB distribution to the active users can be fixed per zone, or the distribution can be biased to one or more type of service users.

Referring to block 460, modeling system 240 may calculate a total capacity for the cell. For example, the total capacity for cell 140 may be a simple sum or weighted sum of the capacity-per-zone of each of zones 150-1 through 150-5. The total capacity may provide, for example, a more accurate guide for mobility planning and more precise location-dependent planning for FWA device placement. The total capacity estimation may be updated periodically (e.g., weekly, monthly, etc.), for use in monitoring, identifying new FWA sale opportunities, and demand forecasting.

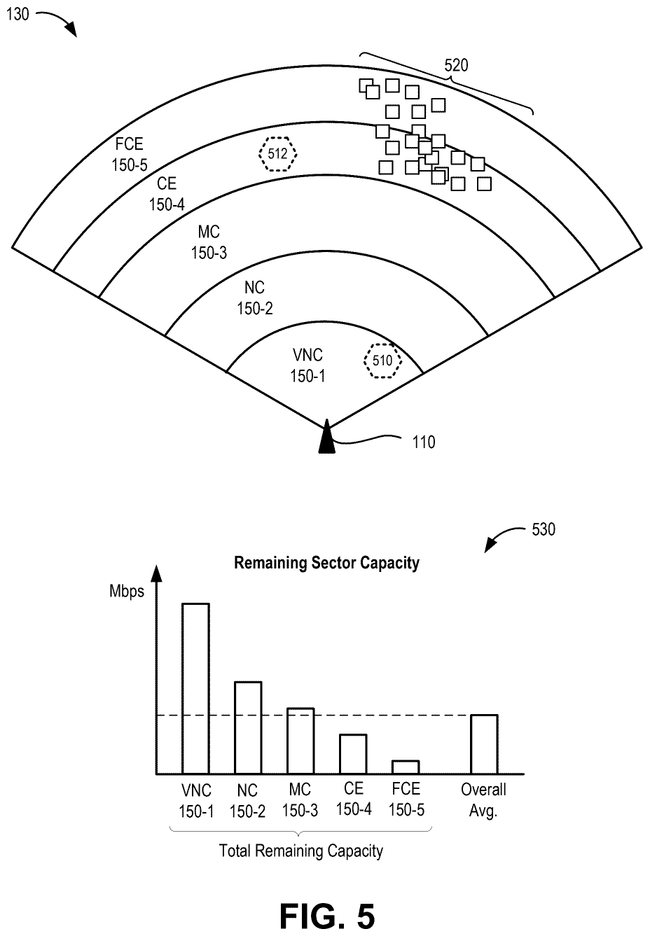

FIG. 5 is a diagram illustrating a planning scenario for new device placement and/or increased mobility use within cell 140. OAM platform 260, for example, may retrieve from modeling system 240 a capacity density model for cell 140. The capacity density model may estimate remaining capacity in each of zones 150 based on historical data from devices in cell 140. A chart 530, which may be based on the capacity density model, illustrates the remaining capacity available in each of zones 150 within cell 140.

Assume, in the example of FIG. 5, that proposals are submitted for installation of two FWA devices 510 and 512 at different locations within cell 140. FWA devices 510 and 512 may be identified by service type for fixed-location, high-bandwidth service. Further, assume that the total available capacity of cell 140 indicates required service levels for each of FWA devices 510 and 512 could be supported. OAM platform 260 may apply a zone-specific analysis to each of proposed FWA devices 510 and 512. Placement of FWA device 510, located in VNC zone 150-1, may be accepted since the available capacity is sufficient. However, placement of FWA device 512, located in CE zone 150-4, may be denied or rejected under the current wireless infrastructure, since the available capacity is insufficient to support fixed-location, high-bandwidth service. In contrast, a decision to accept or reject FWA devices 510/512 based on the overall average capacity of cell 140 may overestimate and underestimate, respectively, the capacity at zones 150-1 and 150-4.

As another example, assume forecasted user density patterns indicate an increased number of mobile users 520 (e.g., using UE devices 210) expected in CE zone 150-4 and FCE zone 150-5 of cell 140 (e.g., due to building a new development, housing complex, etc.). OAM platform 260 may apply a zone-specific analysis to determine if the capacity in the impacted zones is sufficient to support the increased user density, and if the total cell capacity is sufficient for projected mobility patterns in each zone 150.

OAM platform 260 may generate recommendations to address projected capacity shortfalls. In one implementation, OAM platform 260 may identify software-based solutions (e.g., antenna tilt, MCS selection algorithms, etc.) to periodically adjust capacity within different zones 150 of cell 140, such as adjustment for times of day, commuting patterns, etc. Adjusting capacity may include, for example, applying a modulation and coding scheme (MCS) to increase capacity in one of the zones 510 and decrease capacity in another one of the zones 150. In other implementations, OAM platform 260 may recommend additional hardware solutions, such as small cells, additional antennas, etc.

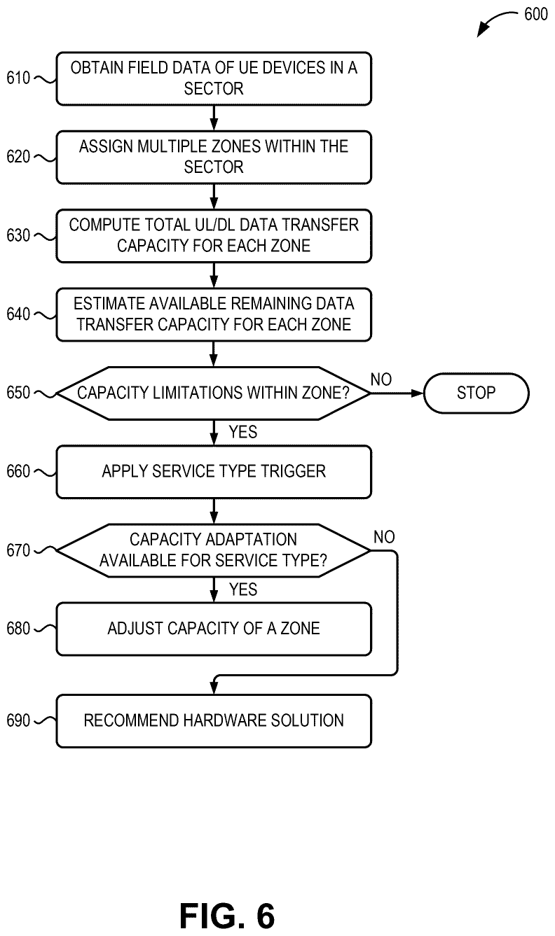

FIG. 6 is a flow diagram illustrating an exemplary process 600 for managing total cell capacity over a band in a cell or sector. In one implementation, process 600 may be implemented by modeling system 240. In another implementation, process 600 may be implemented by modeling system 240 in conjunction with one or more other network devices in network environment 200.

Process 600 may include obtaining field data of UE devices for a cell (block 610). For example, modeling system 240 may retrieve (e.g., from data collection system 250) field data reported by UE devices 210 from cell 140 and/or field data reported by access station 225. In one implementation, the field data may provide historical measurement reports that may include location coordinates and received signal strength measurements. In another implementation, the field data may include historical records of channel quality indicators (CQIs) and/or PDCCH grant aggregation levels used for connections with UE devices 210.

Process 600 may also include assigning multiple zones within the cell (block 620). For example, modeling system 240 may assign, based on the field data, multiple zones 150-1-150-5 within cell 140. Each of the multiple zones may correspond to a different link adaptation setting assigned to UE devices. In one implementation, a set of capacity zones 150 may be assigned for DL data transfers based on one type of field data. In another implementation, another set of capacity zones 150 may be assigned for UL data transfers based on another type of field data. In one example, each zone 150 may correspond to an area of coverage in cell 140 where devices may be assigned to use a certain PDCCH aggregation level (e.g., one of aggregation levels 1, 2, 4, 8, or 16). In another example, modeling system 240 may assign zones based on different criteria, such as a coverage area with a certain CQI or CQI range.

Process 600 may further include computing a total UL and/or DL data transfer capacity for each zone (block 630). For example, modeling system 240 may compute a total data transfer capacity to UE devices (e.g., downlink) in a band for each zone 150-1 through 150-5, and a total data transfer capacity from UE devices (e.g., uplink) in a band for each zone 150-1 through 150-5. In one implementation, the total UL/DL data transfer capacity for each zone may be based on the amount of available PRBs for the cell 140 and the link adaptation settings used in each zone 150. The PRBs may be allocated fairly between zones based on number of users and types of service (e.g., mobile, FWA, etc.) in each zone 150 of cell 140.

Process 600 may additionally include estimating an available remaining data transfer capacity for each zone (block 640). For example, modeling system 240 may estimate a current available remaining data transfer capacity for each zone 150 based on the field data received from data collection system 250 and the total data transfer capacity modeling system 240 previously calculated for each zone.

Process 600 may further include determining if there is a capacity limitation within a zone (block 650). For example, modeling system 240 may determine that a remaining DL data transfer capacity within a zone is above a DL threshold (e.g., above 80% capacity or another level). Additionally, modeling system 240 may determine that a remaining UL data transfer capacity within the zone is above an UL threshold (e.g., a same or different capacity threshold than the DL threshold). As another example, modeling system may determine (1) if there is a capacity limitation based on estimated requirements for a DL/UL data transfer capacity required for Fixed Wireless Access (FWA) services and (2) if there is a capacity limitation based on estimated requirements for a DL/UL data transfer capacity for mobility services. Alternatively, modeling system 240 may be requested to assess if a projected mobility pattern change (e.g., housing or commuting growth in a zone) or FWA installation will cause capacity issues within a zone 150.

If there is no capacity limitation within a zone (block 650—No), process 600 may end. If there is a capacity limitation within a zone (block 650—Yes), process 600 may include applying a service type trigger (block 660) and determining if a capacity adaptation is available for a service type (block 670). For example, modelling system 240 may determine whether a service type for a projected capacity addition is for a typical UE device 210 or a FWA device (e.g., FWA 510/512). Modeling system 240 may, for example, determine that capacity of zones 150 in cell 140 may be adjusted using software and coding schemes to provide some increased capacity for new mobility traffic. Alternatively, modeling system 240 may determine that a more capacity-intensive installation (e.g., a FWA) may not be accommodated via software and coding schemes.

If a capacity adaptation is available for the service type (block 670—Yes), process 600 may include adjusting a capacity of a zone (block 680). For example, OAM platform 260 may adjust capacity from one zone 150 to another zone 150. In one implementation, OAM platform 260 may identify software-based solutions (e.g., antenna tilt, MCS selection algorithms, etc.) to periodically adjust capacity within different zones 150 of cell 140.

If a capacity adaptation is not available for the service type (block 670—No), process 600 may include recommending a hardware solution (block 690). For example, if software solutions cannot create needed capacity for placement of a device (e.g., an FWA device) or mobility group (e.g., of individual UE devices 210) in a particular zone, modeling system 240 may recommend a small cell placement to provide increased capacity within a cell 140. As another possible solution, modeling system 240 may recommend adding a new band/frequency on the same access station to prop up the sector capacity.

Systems and methods described herein provide a total cell capacity estimation process that accounts for variability of spectral efficiency within a cell and enables optimized cell adjustments. The systems and methods can be applied for both DL and UL data transfer capacities. A network device may obtain field data of UE devices for a cell and assigns, based on the field data, multiple zones within the cell. Each of the multiple zones may correspond to a different link adaptation setting for UE devices. The network device computes a total data transfer capacity in a band for each zone of the multiple zones and may estimate a current available remaining data transfer capacity for each zone of the multiple zones based on the field data and the total data transfer capacity for each zone. A data transfer capacity in one of the multiple zones may be adjusted based on the estimate.

The foregoing description of embodiments provides illustration but is not intended to be exhaustive or to limit the embodiments to the precise form disclosed. Accordingly, modifications to the embodiments described herein may be possible. The description and drawings are accordingly to be regarded as illustrative rather than restrictive.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of blocks have been described with regard to the processes illustrated in FIGS. 4 and 6, the order of the blocks may be modified according to other embodiments. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 320, etc.), or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 320) of a device. A non-transitory storage medium includes one or more of the storage mediums described in relation to memory 330.

To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such. All structural and functional equivalents to the elements of the various aspects set forth in this disclosure that are known or later come to be known are expressly incorporated herein by reference and are intended to be encompassed by the claims.

What is claimed is:

1. A method comprising:
obtaining, by a computing device, field data of user equipment (UE) devices for a cell;
assigning, by the computing device and based on the field data, multiple zones within the cell, wherein each of the multiple zones corresponds to a different link adaptation setting for UE devices;
computing, by the computing device, a total data transfer capacity in a band, for each zone of the multiple zones; and
estimating, by the computing device, a current available remaining data transfer capacity for each zone of the multiple zones based on the field data and the total data transfer capacity for each zone; and
adjusting, based on the estimating, a data transfer capacity in one of the multiple zones.

2. The method of claim 1, wherein the adjusting further comprises:
adjusting a modulation and coding scheme (MCS) to increase capacity in one of the multiple zones and decrease capacity in another one of the multiple zones.

3. The method of claim 1, further comprising:
projecting, by the computing device, a future available remaining data transfer capacity for each zone of the multiple zones based on the field data and a data transfer capacity for each zone.

4. The method of claim 1, wherein computing the total data transfer capacity includes allocating all shared data channel physical resource blocks (PRBs) available for the cell among the multiple zones.

5. The method of claim 4, wherein the allocating includes allocating data channel PRBs based on a number of users and types of service in each zone of the multiple zones.

6. The method of claim 1, wherein estimating the current available remaining data transfer capacity further includes:
estimating a first data transfer capacity for Fixed Wireless Access (FWA) services; and
estimating a second data transfer capacity for mobility services.

7. The method of claim 1, further comprising:
receiving a proposal for a Fixed Wireless Access (FWA) installation, wherein the proposal identifies a location of a FWA device;
associating the location of a FWA device with a zone of the multiple zones; and
accepting or denying the proposal based on the location of a FWA device and the current available remaining data transfer capacity of the zone.

8. The method of claim 7, wherein receiving the proposal further includes receiving data transfer requirements for the FWA device.

9. The method of claim 1, wherein each of the multiple zones corresponds to:
a different Physical Downlink Control Channel (PDCCH) grant aggregation level, or
a different channel quality indicator (CQI) or rank indicator (RI).

10. The method of claim 1, wherein computing the total data transfer capacity includes:
computing a total downlink (DL) data transfer capacity, or
computing a total uplink (UL) data transfer capacity.

11. A network device, comprising:
a processor configured to:
obtain field data of user equipment (UE) devices for a cell;
assign, based on the field data, multiple zones within the cell, wherein each of the multiple zones corresponds to a different link adaptation setting for UE devices;
compute a total data transfer capacity for each zone of the multiple zones; and
estimate a current available remaining data transfer capacity for each zone of the multiple zones based on the field data and the total data transfer capacity for each zone.

12. The network device of claim 11, wherein the processor is further configured to:
adjust, based on the current available remaining data transfer capacity for each zone, a modulation and coding scheme (MCS) to increase capacity in one of the multiple zones and decrease capacity in another one of the multiple zones.

13. The network device of claim 11, wherein the field data includes Physical Uplink Shared Channel (PUSCH) signal-to-interference and noise-ratio (SINR) measurements or Physical Downlink Control Channel (PDCCH) grant aggregation levels.

14. The network device of claim 11, wherein, when computing the total data transfer capacity, the processor is further configured to:
allocate all shared data channel physical resource blocks (PRBs) available for the cell among the multiple zones.

15. The network device of claim 11, wherein the processor is further configured to:
project a future available remaining data transfer capacity for each zone of the multiple zones based on the field data and the total data transfer capacity for each zone.

16. The network device of claim 11, wherein, when estimating the current available remaining data transfer capacity, the processor is further configured to:
estimate a first data transfer capacity for Fixed Wireless Access (FWA) services; and
estimate a second data transfer capacity for mobility services.

17. The network device of claim 11, wherein each of the multiple zones corresponds to a different Physical Downlink Control Channel (PDCCH) grant aggregation level or a different channel quality indicator (CQI).

18. A non-transitory computer-readable medium storing instructions, which are executable by one or more processors, for:
obtaining, by a computing device, field data of user equipment (UE) devices for a cell;
assigning, by the computing device and based on the field data, multiple zones within the cell, wherein each of the multiple zones corresponds to a different link adaptation setting for UE devices;
computing, by the computing device, a total data transfer capacity for each zone of the multiple zones;
estimating, by the computing device, a current available remaining data transfer capacity for each zone of the multiple zones based on the field data and the total data transfer capacity for each zone; and
adjusting, based on the estimating, a data transfer capacity in one of the multiple zones.

19. The non-transitory computer-readable medium of claim 17, further comprising instructions for:
adjusting, based on the current available remaining data transfer capacity for each zone, a modulation and coding scheme (MCS) to increase capacity in one of the multiple zones and decrease capacity in another one of the multiple zones.

20. The non-transitory computer-readable medium of claim 18, wherein each of the multiple zones corresponds to a different Physical Downlink Control Channel (PDCCH) grant aggregation level or a different channel quality indicator (CQI).
